(19) United States
(12) Patent Application Publication
(10) Pub. No.: US 2006/0192474 A1
(43) Pub. Date: Aug. 31, 2006

(54) Plasma display panel and method for forming the same

(75) Inventors: Tae Woo Kim, Youngin-si (KR); Jeong Nam Kim, Youngin-si (KR); Byoung Min Chun, Youngin-si (KR); Jeong Doo Yi, Youngin-si (KR)

Correspondence Address: LEE & MORSE, P.C., SUITE 2000, 1101 WILSON BOULEVARD, ARLINGTON, VA, 22209, US

(73) Assignee: Samsung SDI Co., Ltd.

(21) Appl. No.: 11/354,234

(22) Filed: Feb. 15, 2006

(30) Foreign Application Priority Data
Feb. 16, 2005 (KR) 2005-0012745

(51) Int. Cl. H01J 63/04

(52) U.S. Cl. 313/491

(57) ABSTRACT

A plasma display panel includes a front and rear substrates separated from each other by a distance and defining a space therebetween to contain a discharge gas, a partition on the front substrate, the partition to separate the space into discharge cells, electrodes on the rear substrate, the electrodes to generate discharge in the discharge cells and a phosphor material in the discharge cells and on the front substrate.

### BACKGROUND OF THE INVENTION

1. Field of the Invention

The present invention relates to a plasma display panel. More particularly, the present invention relates to a layout of electrodes and partitions of a plasma display panel and a method for forming the same.

2. Description of the Prior Art

A plasma display device typically refers to a flat plate-shaped display device using a plasma display panel (PDP), which also may be referred to herein as a panel, including two facing substrates spaced a predetermined distance apart and with intersecting electrodes therebetween. The space between the substrates is sealed after injecting discharge gas therebetween. After the PDP is formed, components necessary for realizing a display, including a driving circuit, are arranged relative to the PDP and connected to the electrodes of the panel.

PDPs are typically thinner than cathode ray tube (CRT) display devices, which occupy a large volume. Thus, a PDP is suitable for realizing a large, lightweight screen that occupies a small volume. In addition, PDPs have advantages over other flat display devices, e.g., liquid crystal displays (LCDs). For example, unlike LCDs, PDPs do not include large numbers of active devices, e.g., transistors, and PDPs generally have wider viewing angle and higher luminance than LCDs.

PDPs have a large number of pixels arranged in a matrix to display a screen. Each pixel in the PDP may be driven by simply applying a voltage to the electrode without any active device for driving the pixel. That is, the PDP operates in a passive matrix mode. PDPs may be classified into DC-type panels and AC-type panels according to the type of driving signal used. PDPs may also be classified into facing-type panels and surface discharge-type panels according to the arrangement of the electrodes to which sustain discharge voltage is applied.

In a DC-type panel, the electrodes are exposed to the discharge space and the current directly flows through the electrodes from the discharge space. Therefore, the DC-type panel has a problem in that the electrodes must be protected and separate resistors must be provided and connected to the electrodes to adjust the current. In contrast, in an AC-type panel, the electrodes are covered with a dielectric material and naturally have an electrostatic capacity. Current flowing through the electrodes is limited and the electrodes are easily protected from ion shock during discharge. This prolongs the life of the electrodes.

In a conventional AC three-electrode surface discharge-type plasma display panel, electrodes are distributed on two substrates. For example, partitions and address electrodes are on the rear substrate and common electrodes and scanning electrodes, alternating with each other, are on the front substrate in a direction perpendicular to the address electrodes.

An example of a conventional process of forming electrodes on the front and rear substrates will now be described in more detail. An inner surface of the front substrate may be cleaned. A transparent electrode material film may be formed on the surface of the substrate and subjected to a photolithography process to form transparent electrode patterns for scanning electrodes and common electrodes. Bus electrodes may be formed on the substrate having the transparent electrode patterns formed thereon. The bus electrodes may be formed in a pattern printing method or in a photolithography method preceded by electrode film formation on the front surface of the substrate. After pattern formation, firing may be additionally performed to consolidate and fix the film body. A dielectric film formation process may be performed on both electrodes in one or two passes. A magnesium oxide (MgO) film may be formed on the dielectric film as a protective film using a suitable method, e.g., deposition.

An inner surface of the rear substrate may be cleaned and address electrodes may be formed thereon in a printing process or in a photolithography process preceded by film formation. A separate dielectric film may be formed on the electrodes. Partitions may be formed parallel to the address electrodes. The partitions may be formed by providing a film for partitions, exposing i to light, and forming patterns by sand blasting. Then, a phosphor material layer may be formed on the substrate. Each pixel includes three discharge cells (RGB) to realize full color images. Each phosphor material may be subjected to a photolithography or printing process so that it has a proper color in each discharge cell.

After the above processes are complete, frit glass may be provided in the periphery of the facing surfaces, i.e., inner surfaces, of both substrates. The substrates are then aligned and sealed. A vent may be formed to evacuate air from the space between the substrates and inject discharge gas needed for plasma discharge. After discharge gas is injected, the substrates are sealed and a PDP is completed.

However, PDPs with a conventional structure subject each substrate to material film formation and patterning processes a number of times. This consumes time and increases costs wtih each process step.

### SUMMARY OF THE INVENTION

The present invention is therefore directed to a plasma display panel (PDP) and method for forming the same, which substantially overcome one or more of the problems due to the limitations and disadvantages of the related art.

It is therefore a feature of an embodiment of the present invention to provide a PDP that can be simply made, resulting in a reduced number of steps and a simplified method for forming the same.

It is another feature of an embodiment of the present invention to provide a PDP having a high forward emission efficiency, and a method for forming the same.

It is yet another feature of an embodiment of the present invention to provide a PDP having a low discharging voltage, and a method for forming the same.

It is still another feature of an embodiment of the present invention to provide a PDP having reduced power consumption, and a method for forming the same.

It is a further feature of an embodiment of the present invention to provide a PDP having reduced damage to the phosphor material, thus increasing lifetime, and a method for forming the same.

At least one of the above and other embodiments may be realized by providing a plasma display panel, including front and rear substrates separated from each other by a distance and defining a space therebetween to contain a discharge gas, a partition on the front substrate, the partition to separate the space into discharge cells, electrodes on the rear substrate, the electrodes to generate discharge in the discharge cells and a phosphor material in the discharge cells and on the front substrate.

The electrodes may include address electrodes and sustain electrodes intersecting the address electrodes, the sustain electrodes and the address electrodes having an interlayer dielectric layer therebetween. The sustain electrodes may include two kinds of electrodes alternately arranged. The sustain electrodes may further include middle electrodes between the two kinds of electrodes. An upper dielectric layer may cover the address electrodes and the sustain electrodes. A protective film may be on the upper dielectric layer. The sustain electrodes may be closer to the rear substrate than the address electrodes.

All of the electrodes may be reflective. The phosphor material may be optically transmissive. The partition may be formed in a lattice pattern to delimit each discharge cell.

At least one of the above and other embodiments may be realized by providing a method for forming a plasma display panel, including providing a rear substrate, forming first electrodes on an inner surface of the rear substrate, forming an interlayer dielectric film on the first electrodes, forming second electrodes on the interlayer dielectric film, the second electrodes intersecting the first electrodes, forming an upper dielectric film on the second electrodes, providing a front substrate and forming a phosphor material pattern on an inner surface of the front substrate, the inner surface of the front substrate facing the inner surface of the rear substrate.

A partition may be formed on the inner surface of the front substrate before forming the phosphor material pattern. Forming the partition may include forming a mask pattern on the inner surface of the front substrate, which has a partition layer formed thereon and etching the partition layer by sand blast using the mask pattern.

Forming each of the first electrodes, the interlayer dielectric film, the second electrodes, the upper dielectric film and the phosphor material pattern may include printing, drying and firing. The first electrodes are address electrodes and the second electrodes are sustain electrodes.

The method may further include positioning a sealant on a periphery of the front substrate having the phosphor material pattern formed thereon, aligning the front and rear substrates with each other and temporarily sealing them and evacuating the space between the substrates via a vent formed thereon, injecting discharge gas, and sealing the vent.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective schematic view of a pixel unit of a plasma display panel according to an embodiment of the present invention;

FIG. 2 illustrates a cross-sectional schematic view of a pixel unit of a plasma display panel according to another embodiment of the present invention; and

FIGS. 3 and 4 illustrate top schematic views of an electrode layout and driving mode used for discharge in a plasma display panel according to embodiments of the present invention.

### DETAILED DESCRIPTION OF THE PRESENT INVENTION

Korean Patent Application No. 2005-0012745 filed on Feb. 16, 2005, in the Korean Intellectual Property Office, and entitled: “Plasma Display Panel and Method for Forming the Same,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. In the following description and drawings, like reference numerals are used to designate the same or similar components, and so repetition of the description on the same or similar components will be omitted.

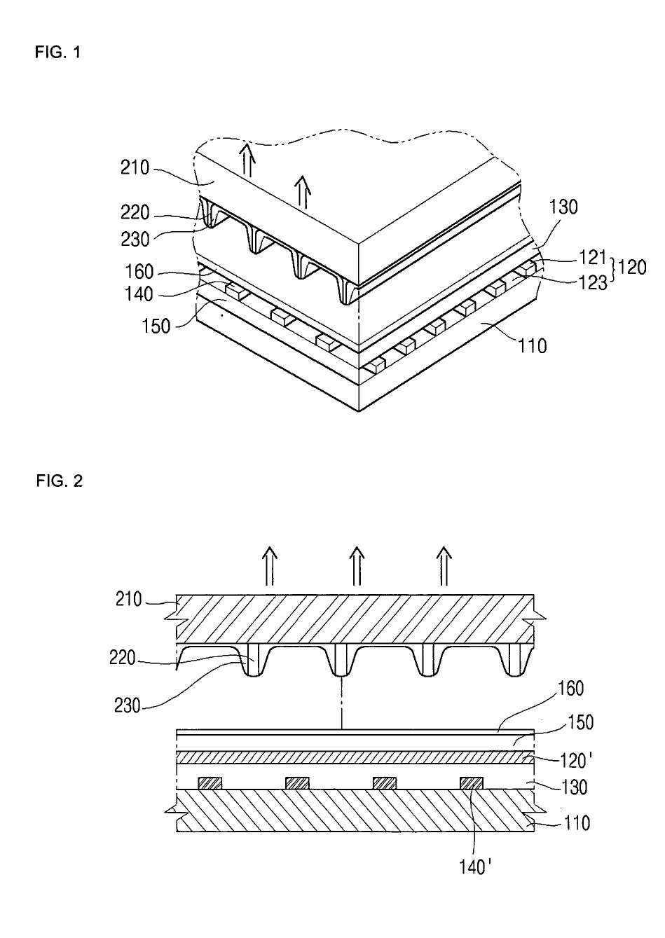

FIG. 1 illustrates an exploded perspective view of a pixel unit of a plasma display panel (PDP) according to an embodiment of the present invention.

The structure and method of forming a panel according to the present invention will now be described with reference to FIG. 1. The PDP may include a front substrate 210 and a rear substrate 110. Sustain electrodes 120 may be formed on the rear substrate 110. The sustain electrodes 120 may include common electrodes 121 and scanning electrodes 123 alternating with each other in the horizontal direction. A first dielectric film 150 may cover the sustain electrodes 120. Address electrodes 140 may be formed on the first dielectric film 150 and a second dielectric film 130 may be positioned thereon. The address electrodes 140 may cross the sustain electrodes 120 while being perpendicular thereto, i.e., intersect the sustain electrodes. A protective film 160, e.g. MgO, may be formed on the second dielectric film 130.

When forming a panel, the electrodes and material films including the dielectric films and the protective films may be laminated on the substrate by various methods including printing, deposition, and sputtering based on necessary working precision and cost. Drying and firing may be subsequently performed to consolidate the printed film body. When forming patterns on the material films, a photolithography process may be used, in which a mask pattern is formed on a target film and, after an exposure process, the target film may be removed according to the mask pattern.

Partitions 220 may be formed on the (inner) surface of the front substrate 210 facing the rear substrate 110. The partitions 220 may be formed in various shapes and by various methods. For example, partitions may be formed by laminating a partition material layer on the front surface of a glass substrate and subjecting it to photolithography. When etching the partition material layer according to a mask pattern formed thereon, a physical etching method, e.g., sand blasting, may be more efficient than chemical etching methods. The partitions 220 may be formed in a stripe pattern parallel to the address electrodes 140 or in a lattice pattern. The mask pattern may be partially removed during the etching process and any remaining mask pattern may be removed by a separate treatment, e.g., a chemical and thermal treatment.

The front substrate 210 may have a phosphor material 230 positioned for each cell on the inner surface thereof, i.e., on the surface having the partitions 220 thereon. The phosphor material may be provided in various conventional methods. For example, a phosphor material may be applied to each cell corresponding to each RGB color and patterned.

After forming structures including electrodes and partitions on the rear and front substrates, respectively, rear and front substrates 110, 210 may be aligned to position the electrodes 120, 140 and the partitions 220 therebetween and may be subjected to a sealing process. For the sealing process, frit glass may be applied to the periphery of the inner surface of at least one of rear and front substrates in a continuous manner. Then, the rear and front substrates may be aligned with and secured to each other. As a result, a sealed space may be formed, with its front and rear surfaces delimited by the substrates and the lateral surfaces blocked by the frit glass on four sides. In addition, a cell structure may be formed in each pixel as shown in FIG. 1.

It will be apparent to those skilled in the art that, although not shown, additional process, such as forming vents on parts of the substrates, evacuating air from the space between the substrates, injecting discharge gas and sealing the vents may be performed.

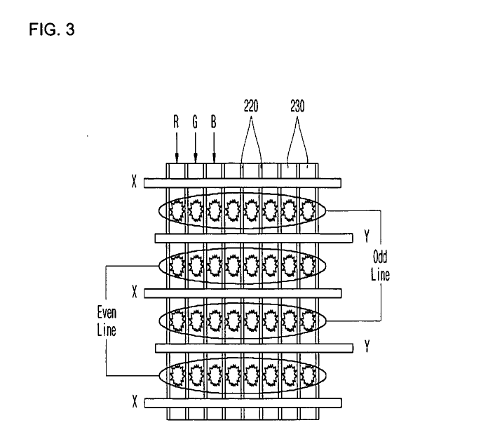

FIG. 2 illustrates a cross-sectional view of a pixel unit of a plasma display panel according to another embodiment of the present invention.

The structure and formation procedure of the embodiment shown in FIG. 2 is similar to those of the embodiment shown in FIG. 1 except that, while sustain electrodes 120 are first formed on the rear substrate 110 in the embodiment of FIG. 1, in FIG. 2, address electrodes 140′ are first formed and sustain electrodes 120′ are formed on the upper layer which is spaced from them by the dielectric film 130. A protective film 160, e.g., an MgO film, may be provided on the dielectric film 150 positioned on top of the sustain electrodes.

In the above embodiments, the PDP is assumed to use forward emission, i.e., the viewing surface is an outer surface of the front substrate 210. Therefore, none of the electrodes need to be transparent and may be made of a highly reflective layer, e.g., a glossy metal electrode layer or inter-metal alloy layer, to improve the reflection efficiency from the rear substrate. When metal electrodes are used, their excellent electrical conductivity may make additional bus electrodes for the sustain electrodes unnecessary.

Partitions 220 may be formed on an inner surface of the front substrate 210. Since partitions 220 are formed on the front substrate 210 without any electrode structure, including address electrodes, the partitions can be formed more efficiently. For example, in forming the partitions 220, a partition material layer may be laminated the front substrate 210. A mask pattern may be formed on the laminated partition material in a conventional exposure or printing process. Then, chemical etching or physical etching, e.g., sand blasting, may be performed. After the mask pattern is removed, the front substrate 210 having partitions 220 formed thereon is obtained.

Various techniques may be used to provide a phosphor material 230 for each cell on the front substrate 210 having partitions 220 formed thereon. For example, front fluorescent film application and photolithography may be performed to leave a phosphor material having a specific color on predetermined cells. This procedure may be repeated as many times as the number of the colors. Instead of photolithography, printing and firing may be performed. It is also possible to simultaneously form patterns of RGB three-color phosphor material in line with the development of printing technology.

In the case of forward emission, light propagates through the phosphor material in the cell space and displays an image on the screen. In this structure, a conventional transmissive fluorescent, i.e., transparent phosphor material, is used. Since the electrodes 120, 140 are on parts of the PDP without phosphor material, i.e., on the rear substrate 110, the phosphor material 230 is less likely to be damaged by the discharge around the electrodes.

The partitions may have the shape of a stripe or lattice. Since better emission efficiency may be obtained when the phosphor material is formed on the partitions in a larger area with a thickness larger than that of the surface of the substrate, lattice partitions may be advantageous. When transparent electrodes and bus electrodes are used in the lattice partitions, the partitions and the bus electrodes of the sustain electrodes preferably overlap each other to increase the aperture ratio.

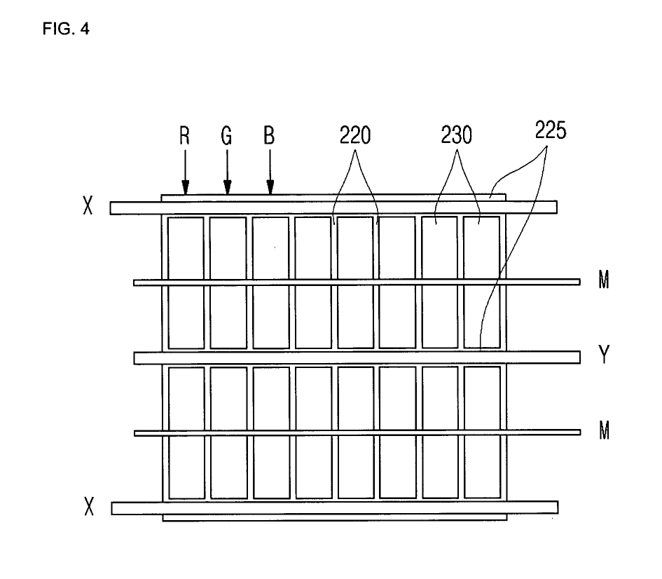

FIGS. 3 and 4 illustrate top views of electrode layouts and driving modes used for discharge in a plasma display panel according to further embodiments of the present invention.

The structure of the partitions 220, the phosphor material 230, and the electrodes of the substrate of the embodiment shown in FIG. 3 may be similar to that of the embodiment shown in FIG. 2, except that the electrodes in the embodiment of FIG. 3 are driven in an alternative lighting of surface (ALIS) mode.

In a conventional AC three-electrode surface-discharge structure, each cell has a sustain electrode, including common or display electrode X and a scanning electrode Y, and an address electrode (not shown) intersecting the sustain electrode. With such an electrode layout and using AC-discharge, however, the effective discharge region throughout the whole screen is limited and the overall luminance and discharge efficiency degrade. This increases the power consumption. However, with such an electrode layout and using ALIS driving mode, common electrodes X and scanning electrodes Y constituting sustain electrodes are alternately used for discharge of odd lines at one time and used for discharge of even lines at another time. Therefore, the number of scanning lines may be doubled without increasing a number of sustain electrodes, thereby increasing the discharge region and improving the discharge efficiency.

Referring to FIG. 4, middle electrodes M further may be provided between the electrodes X and the electrodes Y configured as shown in FIG. 3, providing a four-electrode structure together with address electrodes (not shown). In this four-electrode structure, initial discharge (address discharge) may occur between the middle electrodes M and the address electrodes. Surface charge may be accumulated through the initial discharge and may be followed by display discharge between sustain electrodes. Since the spacing between the middle electrodes M and the address electrodes is smaller than that of address electrodes positioned on the other substrate, as in the conventional arrangement, discharge occurs easily even with small difference in electrical potential, thus decreasing power consumption. Display discharge occurs as alternating voltage is applied between the electrodes X and the electrodes Y. In this embodiment, the gaps between the electrodes X and the electrodes Y may be increased, and discharge may be generated in almost an entire area of the cell, increasing the discharge efficiency. It is also possible to apply a voltage to the middle electrodes during sustain or display discharge so that the middle electrode serves as the cathode or anode, thereby facilitating discharge.

The present invention is advantageous in that formation of a PDP is simplified, reducing manufacturing cost and time. Particularly, partitions can be processed easily and no separate bus electrodes are necessary.

In addition, no electrodes need to be formed on the front surface. Further, assuming that a transparent phosphor material is used, the aperture ratio and the forward emission efficiency can be increased, thus decreasing the discharge voltage and power consumption.

Since the phosphor material is not positioned adjacent to the electrodes, it is less likely to be damaged, prolonging the life of the panel. In addition, since the protective layer is not in the path of light, more materials are available to be used for the protective layer, including colored MgO.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
front and rear substrates separated from each other by a distance and defining a space therebetween to contain a discharge gas;
a partition on the front substrate, the partition to separate the space into discharge cells;
electrodes on the rear substrate, the electrodes to generate discharge in the discharge cells; and
a phosphor material in the discharge cells and on the front substrate.

2. The plasma display panel as claimed in claim 1, wherein the electrodes comprise:
address electrodes; and
sustain electrodes intersecting the address electrodes, the sustain electrodes and the address electrodes having an interlayer dielectric layer therebetween.

3. The plasma display panel as claimed in claim 2, wherein the sustain electrodes comprise two kinds of electrodes alternately arranged.

4. The plasma display panel as claimed in claim 3, wherein the electrodes further comprise middle electrodes between the two kinds of electrodes.

5. The plasma display panel as claimed in claim 2, further comprising an upper dielectric layer covering the address electrodes and the sustain electrodes.

6. The plasma display panel as claimed in claim 5, further comprising a protective film on the upper dielectric layer.

7. The plasma display panel as claimed in claim 2, wherein the sustain electrodes are closer to the rear substrate than the address electrodes.

8. The plasma display panel as claimed in claim 1, wherein all of the electrodes are reflective.

9. The plasma display panel as claimed in claim 1, wherein the phosphor material is optically transmissive.

10. The plasma display panel as claimed in claim 1, wherein the partition is formed in a lattice pattern to delimit each discharge cell.

11. A method for forming a plasma display panel, comprising:
providing a rear substrate;
forming first electrodes on an inner surface of the rear substrate;
forming an interlayer dielectric film on the first electrodes;
forming second electrodes on the interlayer dielectric film, the second electrodes intersecting the first electrodes;
forming an upper dielectric film on the second electrodes;
providing a front substrate; and
forming a phosphor material pattern on an inner surface of the front substrate, the inner surface of the front substrate facing the inner surface of the rear substrate.

12. The method as claimed in claim 11, further comprising forming a partition on the inner surface of the front substrate before forming the phosphor material pattern.

13. The method as claimed in claim 12, wherein forming the partition comprises:
forming a mask pattern on the inner surface of the front substrate, which has a partition layer formed thereon; and
etching the partition layer by sand blast using the mask pattern.

14. The method as claimed in claim 11, wherein forming each of the first electrodes, the interlayer dielectric film, the second electrodes, the upper dielectric film and the phosphor material pattern further comprises printing, drying and firing.

15. The method as claimed in claim 11, wherein the first electrodes are address electrodes and the second electrodes are sustain electrodes.

16. The method as claimed in claim 11, wherein the first electrodes are sustain electrodes and the second electrodes are address electrodes.

17. The method as claimed in claim 11, further comprising:
positioning a sealant on a periphery of the front substrate having the phosphor material pattern formed thereon;
aligning the front and rear substrates with each other and temporarily sealing them; and
evacuating the space between the substrates via a vent formed thereon, injecting discharge gas, and sealing the vent.

18. The method as claimed in claim 11, wherein one of the first and second electrodes are sustain electrodes including two types of electrodes and a middle electrode therebetween.

19. The method as claimed in claim 11, wherein all of the first and second electrodes are reflective.
